(19) United States
(12) Patent Application Publication
(10) Pub. No.: US 2009/0272225 A1
(43) Pub. Date: Nov. 5, 2009

(54) Torque multiplier for bicycles and all other foot pedaled vehicles

(76) Inventor: Paul Sandford Wells, JR., Grover Beach, CA (US)

Correspondence Address: Paul S. Wells Jr.;Apt. D, 966 South 13th street, Grover Beach, CA, 93433, US

(21) Appl. No.: 12/151,128

(22) Filed: May 5, 2008

(51) Int. Cl. F16H 37/06

(52) U.S. Cl. 74/665 GE

(57) ABSTRACT

The embodiment of a torque multiplying mechanism, consisting of a rotating sleeve (9), a pedal extender arm (2), small sprockets (5), a hinge pin (4) attached to each small sprocket and to each pedal extender arm, un-numbered short chains connecting the small sprockets to large sprockets (6), and foot pedals attached to the pedal extender arms. The foot pedals connect the pedal extender arms to the rotating sleeve through the small sprockets, short chains and large sprockets attached to the sleeve. The rotating sleeve then forces the vehicle drive sprocket to turn, with multiplied torque, due to the leverage applied to the short chains by the small sprockets attached to the pedal extender arms.

### BACKGROUND

This revision relates to the patent application for the Torque Multiplier for Bicycles and All Other Foot Pedaled Vehicles, submitted to the United States Patent Office on Apr. 30, 2008.

Some of the design data shown in the drawings submitted with the original patent application submitted on Apr. 30, 2008 still applies, especially Design No. 2, shown on Page No. 18 of the original application.

The revised design still uses dual crank arms, joined by a connecting rod, which has a pedal extender arm at the front end. This pedal extender arm still applies leverage to the crank arm that an ordinary bicycle can not apply. But the rest of the revised design is entirely different and applies much greater multiplied torque to the back wheel of the bike. This will be described in detail, including mechanical engineering calculations, within the Detailed Description section of this revision, following the drawing parts list.

### SUMMARY

This revised torque multiplier installation and operation is unlike any other foot pedaled vehicle. The crank shaft is not rigidly connected to the main vehicle drive sprocket, as it is with an ordinary bicycle.

### DRAWINGS—FIGURES

FIG. 1 shows a right side view of the bicycle frame with the torque multiplier assembly installed. All part numbers are shown and identified by part name on the separate parts list. Some part numbers are shown in phantom view, since they would not be visible from the right side of the bicycle. The drawing scale required to show this installation makes it difficult to examine. For that reason, a supplemental illustration is included (FIG. 1a), with part names, descriptive data and calculations. The calculations are repeated in the DETAILED DESCRIPTION section of this revision.

FIG. 2 is a top view. The details of the torque multiplier assembly and installation are shown here. This drawing shows that the torque multiplier installation does not interfere with crank shaft rotation.

### DRAWINGS—REFERENCE NUMBERS

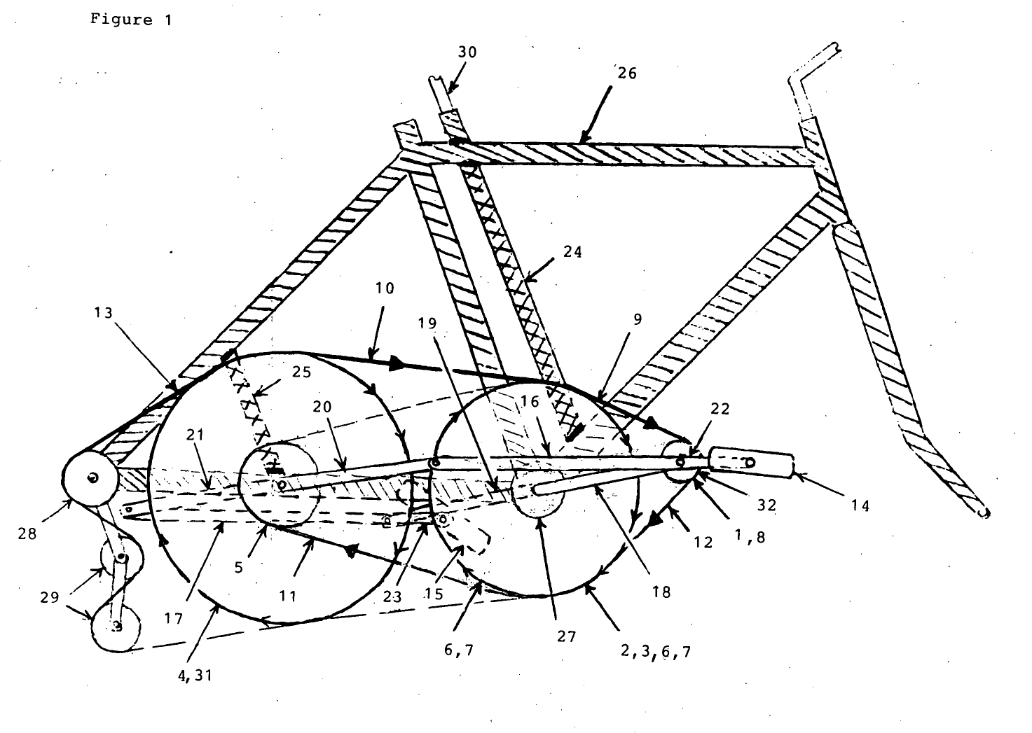

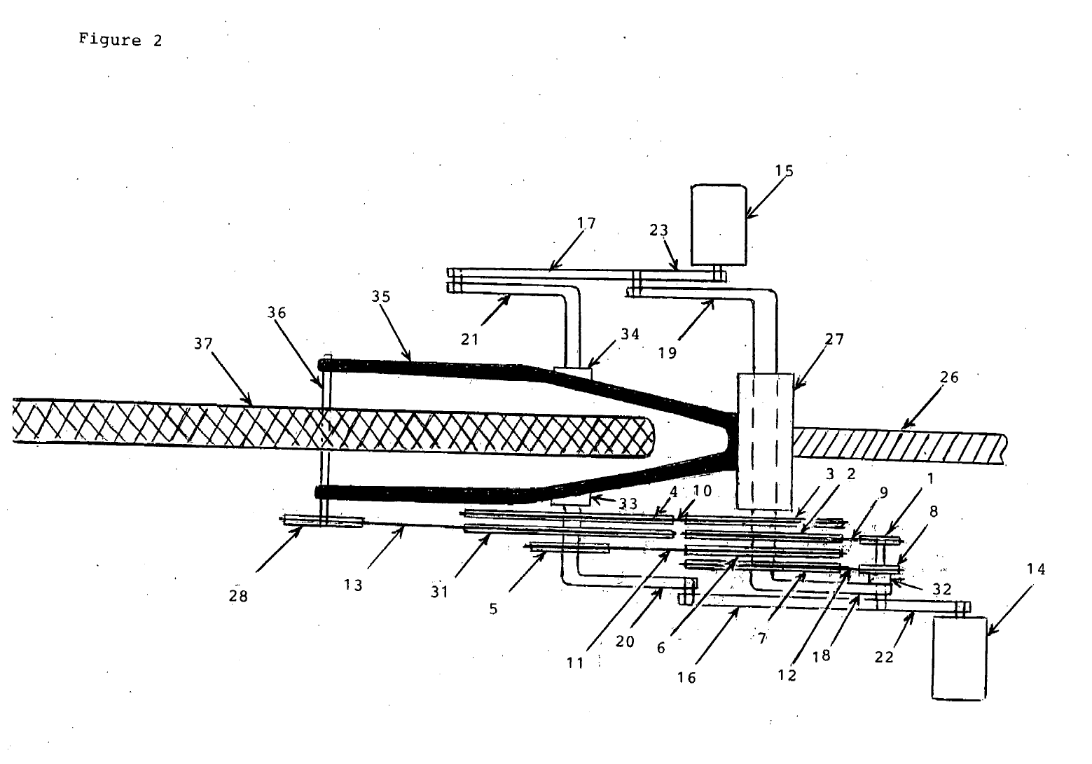

The drawing part numbers for FIG. 1 & FIG. 2 are on Page 3 and Page 4. FIG. 1 and FIG. 2 are on Pages 14 and 15.

FIG. 1a on Page 16

### DRAWINGS_REFERENCE PART NUMBERS

FIG. 1

| | |
|---|---|
| 1 | 0.75 inch sprocket (S1) |
| 2 | 3 inch sprocket (S2) |
| 3 | 3 inch sprocket (S3) |
| 4 | 4 inch sprocket |
| 5 | 1.5 inch sprocket (S5) |
| 6 | 3 inch sprocket (S6) |
| 7 | 3 inch sprocket (S7) |
| 8 | 0.75 inch sprocket (S8) |
| 9 | chain (C1) |
| 10 | chain (C2) |
| 11 | chain (C3) |
| 12 | chain (C4) |
| 13 | chain ((CW) |
| 14 | pedal (right) |
| 15 | pedal (left) |
| 16 | connecting rod (right) |
| 17 | connecting rod (left) |
| 18 | front crank arm (right) |
| 19 | front crank arm (left) |
| 20 | rear crank arm (right) |
| 21 | rear crank arm (left) |
| 22 | pedal extender (right) |
| 23 | pedal extender (left) |
| 24 | added frame member (front) |
| 25 | added frame member (rear) |
| 26 | existing frame |
| 27 | existing crank shaft hub |
| 28 | existing rear wheel sprocket |
| 29 | existing derailer sprockets |
| 30 | seat mast |
| 31 | 4 inch sprocket (SW) |
| 32 | sprage |

### DRAWINGS—REFERENCE PART NUMBERS

FIG. 2

| | |
|---|---|
| 1 | 0.75 inch sprocket (S1) |
| 2 | 3 inch sprocket (S2) |
| 3 | 3 inch sprocket (S3) |
| 4 | 4 inch sprocket (S4) |
| 5 | 1.5 inch sprocket (S5) |
| 6 | 3 inch sprocket (S6) |
| 7 | 3 inch sprocket (S7) |
| 8 | .75 inch sprocket (S8) |
| 9 | chain (C1) |
| 10 | chain (C2) |
| 11 | chain (C3) |
| 12 | chain (C4) |
| 13 | chain (CW) |
| 14 | pedal (right) |
| 15 | pedal (left) |
| 16 | connecting rod (right) |
| 17 | connecting rod (left) |
| 18 | front crank arm (right) |
| 19 | front crank arm (left) |
| 20 | rear crank arm (right) |
| 21 | rear crank arm (left) |
| 22 | pedal extender (right) |
| 23 | pedal extender (left) |
| 24 | added frame member (not shown) |
| 25 | added frame member (not shown) |
| 26 | existing frame (front member) |
| 27 | existing crank shaft hub |
| 28 | existing rear wheel sprocket |
| 29 | existing derailer sprockets |
| | (not shown) |
| 30 | seat mast (not shown) |
| 31 | 4 inch sprocket (SW) |
| 32 | sprage |
| 33 | rear crank bearing (right) |
| 34 | rear crank bearing (left) |
| 35 | existing rear fork |
| 36 | existing rear wheel axle |
| 37 | existing rear wheel |

### DETAILED DESCRIPTION

FIG. 1 and FIG. 2

### Preferred Embodiment

FIG. 1 and FIG. 2 show a right side view and a top view respectively, of the bicycle frame with the torque multiplier assembly installed. The original patent application submitted on Apr. 30, 2008 included two separate designs. Design No. 1 was for single rider. Design No. 2 was for a bicycle built for two.

The revised design shown in this detailed description is more like Design No. 2 and can be used for either a single rider or two riders, with some very minor modifications to the bicycle frame, including adding a second seat and two pedals. But the torque multiplier assembly will not change. The revised patent application in this description has only one design as shown in FIG. No. 1 (side view) and FIG. No. 2 (top view).

Although the new design is partially similar to the previous Design No. 2, (bicycle built for two) there are major differences. The new design has sprockets and chains on only one side of the bicycle. It has two crank arms on each side, which are joined together by a connecting rod, with a pedal crank arm extender attached to the front end of each connecting rod (See FIG. 1) The connecting rods are similar to connecting rods that join two drive wheels on each side of an old fashioned steam locomotive. The connecting rods remain parallel to the ground as the crank arms rotate and they hold the pedal crank arm extenders parallel to the ground as well. This is the same as the bicycle built for two design.

Two small sprockets (0.75 inch radius) are attached to the end of the forward crank arm on right side of the bicycle by a hinge pin. The small sprockets freely rotate on the hinge pin but they are joined together and have to rotate together. This is just the same as the bicycle built for two design.

Two three inch radius sprockets are on the forward crank shaft, which rotates within the existing pedal crank shaft hub. The existing forward crank shaft is also unchanged, except that the two three inch sprockets rotate freely on the crank shaft. The three inch sprockets are joined together and have to rotate together. The existing pedals are removed from the ends of the forward crank arms and attached to the forward ends of the pedal crank arm extenders by their hinge pins.

All of the above is the same as the bicycle built for two design in the patent application of Mar. 30, 2008, except that there is no sleeve passing through the existing forward crank shaft hub with sprockets attached to it, and with the crank shaft rotating freely within the sleeve. No sleeve is required for the new design, which simplifies it considerably. The left side crank arm forces the right side crank arm to rotate, just like any ordinary bicycle.

The bicycle built for two design, with two crank shafts and two connecting rods with crank arm pedal extenders, used alone, will improve the performance of ordinary bicycles slightly. This will be shown by calculations included in this Detailed Description and I wish to keep it included as one of the claims in the original patent application. But the new design in this patent application revision will greatly increase the performance of any bicycle the torque multiplier is installed on. This will be illustrated by the mechanical engineering calculations contained in this Detailed Description. It will also be publicly demonstrated as soon as the prototype bicycle is finished being built, and tested by a certified test lab. The laboratory report will be sent to your office.

Referring to FIG. 1, part numbers 6 and 7 are additional sprockets that are held in place by the forward crank shaft, but rotate freely around it and are fastened together. So they have to rotate together. Part number 4 is a 4 inch (radius) sprocket that is attached to and rotates with the right side rear crank arm (part 20). The crank arm is held in place by a bearing anchored to the existing bicycle rear fork by a support bar (25) that is welded to the bicycle frame. Another sprocket (part 5) is attached to the 4 inch sprocket part 4) and rotates with it. The radius of part 5 is 1.5 inches. A similar bearing and support bar is installed on the left side of the bicycle to hold the crank arm (part 21). There is no crank shaft connected between rear crank arms (parts 20 & 21) because it would interfere with rotation of the rear wheel and is not needed.

Five chains are installed on the right side of the bicycle as shown in FIG. 1 (part No's. 9,10,11,12 and 13). Chain C1, identified as part No. 9 on the parts list on Page 3, is connected between sprocket S1 (part No. 1) and sprocket S2 (part No. 2). Chain C2 (part No. 10) is connected between sprocket S3 (part No. 3) and sprocket S4 (part 4). Chain C3 (part No. 11) is connected between sprocket S5 (part 5) and sprocket S6 (part 6). Chain C4 (part No. 12) is connected between sprocket S7 (part 7) and sprocket S8 (part 8). Chain CW (part 13) is connected between sprocket SW (part 31) and the existing rear wheel sprocket (part 28).

Sprockets S2 and S3 are attached. They rotate together freely on the existing front crank shaft within existing hub (part 27). (Not rigidly connected to the crank shaft). Likewise sprockets S4, S5 and SW are attached and they rotate together. But S4, S5 and SW are rigidly connected to the right side rear crank shaft for crank arm (part No. 20).

Sprockets S6 and S7 are attached. They also rotate freely on the front crank shaft. Finally, sprockets S1 and S8 are attached and they rotate freely on a hinge pin connecting them to the front crank arm (part 18). The hinge pin also connects the front and rear crank arms (parts 18 & 20) to connecting rod (part 16). The hinge pin holding sprockets S1 and S8 to the connecting rod divides the connecting rod into a front pedal extender and the connecting rod between the front and rear crank shafts. The left side connecting rod with pedal extender is the same, except there are no sprockets on the left side. When either the left pedal or the right pedal is forward and is pushed down, the chain (C1) between sprocket S1 and sprocket S2 is pulled forward. Sprocket S2 pulls the attached sprocket (S3). S3 pulls chain C2. Chain C2 pulls sprocket S4 and the sprockets S5 and SW because they are attached to S4. Sprocket S5 pulls chain C3 to sprocket S6. S6 is attached to sprocket S7, which pulls sprocket S8 and S8 pulls sprocket S1. S1 is attached to S8 and to the right front crank arm by a sprage (part No. 32 on FIG. 2). The sprage prevents sprocket S1 from rotating backward, but allows S8 to pull S1 forward.

On smooth flat pavement with no wind, it takes very little foot pedal force to start moving a bicycle. For the following analysis and calculations, 20 lbs. of foot pedal force is used. Calculations using either more or less foot pedal force will yield proportionately similar results.

With 20 lbs. of foot pedal force applied to the front pedal (when forward crank arm is horizontal) downward force is applied to the hinge pin holding sprockets S1 and S8 to the connecting rod. The amount of that force (shown as F1 on FIG. 1) depends on leverage between the back end of the connecting rod, the front pedal and the hinge pin. The overall length of the connecting rod, including pedal extender is 10.5 inches (See FIG. 1a). The pedal extender is 3 inches long. 20 lb×10.5 in=F1×7.5 in, F1=28 lb.

The connecting rod with pedal extender attached will provide leverage to apply force F1 because chain C2 pulls sprocket S4 clockwise and the right rear crank arm is also being pulled down because it is attached to sprocket S4. There are two independent ways to show that F1 will be 28 lbs. with 20 lbs. of foot pedal force applied. One way is the calculation shown on the bottom of the previous page. The other way is to add the 20 lb. foot pedal force to the downward force applied by the right rear crank arm, which must equal the force opposing F1. Either calculation yields F1=28 lbs.

Sprocket S1 can not rotate backward because of a sprage between it and the right front crank arm as shown on FIG. 2 (part 32). So chain C1 will be pulled forward when the foot pedal is pushed down with some chain force (CF1). With 20 lb. applied, F1=28 lb. The crank arm is 4.5 in. long. The radius of sprocket S2 is 3 in. 28 lb.×4.5 in.=CF1×3 in. CF1=42 lb. CF1 is applied to pull the rear wheel in the original design.

If a comparison is made between this 42 lb. chain force CF1 applied to pull the rear wheel of the bicycle and an ordinary bicycle having a 3 inch sprocket and a 4.5 inch crank arm; The ordinary bicycle chain force will be only 30 lbs. This alone shows that a torque multiplied bicycle is better than an ordinary bicycle and this is one claim that I wish to retain in my original patent application. But the revised design in this amended patent application does much more than the original pedal extenders, connecting rods and sprockets S1 and S2 do.

With 20 lbs. or any other foot pedal force applied, chain force CF1 equals chain force CF2 because sprockets S2 and S3 have the same diameter and are attached together. When CF1=42 lbs., CF2=42 lbs. Chain C2 goes to Sprocket S4 and the radius of S4 is 4 inches. But sprocket S5 is attached to S4 and it's radius is only 1.5 inches. Sprocket S5 pulls sprocket S6 with chain force CF3. But sprocket SW (part No. 31 on FIG. No. 1) is also attached to sprocket S4. Chain force C2 of 42 lbs. has to divide between the forces required to pull both chain C3 and CW (part No's. 11 and 13 on FIG. 1). If it takes 20 lbs. of force to pull chain CW (to the bicycle rear Wheel), the force remaining to pull sprocket S5 will be 42 lb.−20 lb.=22 lbs. Calculations using either more or less than 20 lbs. force to chain CW will yield proportionately similar results.

Chain C3 will resist being pulled by sprocket S5 because the radius of sprocket S1 is only 0.75 inches, while the radius of sprocket S5 is 1.5 inches. This means that S1 will have to rotate twice as fast as S5. The right front crank shaft will only rotate sprocket S1 once per revolution of both crank arms. So sprocket S1 will be pulled by sprocket S5 through intermediate sprockets S6,S7,S8 and chain S4.

Even though sprockets S6 and S7 are 3 inch radius, sprocket S1 will rotate twice as fast as S5. The reason sprockets S6 and S7 are not small is that they would cause an undesirable and unbalanced backward torque on the crank arms. Making S6 and S7 larger eliminates negative torque.

With chain force CF2 equal to 42 lbs. and chain force CW equal to 20 lbs. 22 lbs is applied to sprocket S5 by sprocket S4. 22 lbs.×4 in.=CF3×1.5. CF3=58.7 lbs. Chain C3 then applies 58.7 lbs. to sprocket S1 through S6,S7 and S8. 20 lbs. of foot pedal force is applied to pull sprocket (S1) forward, but chain C3 rotates sprocket S1. Never the less, both foot pedal force and chain force C3 pull chain C1 with a force that exceeds the 42 lbs. initially applied.

If chain force CFW to the rear wheel of the bicycle remains at 20 lbs, the force applied to sprocket S5 may equal 58.7−20=38.7 lb. Then 38.7 lbs.×4 in.=CF3×1.5 in. and CF3 may reach 103 lbs. Comparing this with an ordinary bicycle with a 3 inch sprocket and a 4.5 inch crank arm, which produces 30 lbs. of chain force: An ordinary bicycle may reach speeds of 15 to 20 mph with 30 lb of chain force if there is very little wind. With over 100 lbs of chain force, a torque multiplied bicycle might exceed 65 or 70 mph if there was no wind resistance. But wind resistance increases about 4 times as fast as speed and maximum torque only exists when the bicycle pedal is horizontally forward. So the torque multiplied bicycle will accelerate until wind resistance nearly equals chain force C3, but with only about 20 lbs, of foot pedal force applied, which is easy.

The torque multiplied bicycle has another advantage over ordinary bicycles, as described on page 9 through 12 and FIG. 4 of the original patent application. The back pedal still produces forward chain force with little back pedal negative torque on the crank shaft.

In addition to the claims made in the original patent application dated Apr. 30, 2008, the following claims are hereby submitted.

1. A torque multiplier for man powered rotating foot pedaled vehicles, including bicycles, adult tricycles, four wheel vehicles and light aircraft, comprising:
1. The specific assembly of sprockets, chains, crank arms and connecting rods with pedal extenders attached, as shown in FIG. 1 and FIG. 2 of this revised patent application, for the purpose of multiplying the drive chain force produced by foot pedal force.
2. Use of connecting rods between two crank arms to increase foot pedal forward force and eliminate backward crank arm torque produced when foot pedal force is applied to the back pedal.
3. Use of a large sprocket (S4) and a smaller sprocket (S5), attached together to multiply chain force.
